(19) United States
(12) Patent Application Publication
(10) Pub. No.: US 2013/0224062 A1
(43) Pub. Date: Aug. 29, 2013

(54) AUSTENITIC PARAMAGNETIC CORROSION RESISTANT MATERIAL

(71) Applicant: JORGENSEN FORGE CORPORATION, (US)

(72) Inventors: Svetlana Yaguchi, Renton, WA (US); George Luksetich, Renton, WA (US)

(73) Assignee: JORGENSEN FORGE CORPORATION, Seattle, WA (US)

(21) Appl. No.: 13/764,281

(22) Filed: Feb. 11, 2013

Related U.S. Application Data
(63) Continuation of application No. 13/157,146, filed on Jun. 9, 2011, now abandoned.
Application No. 13/157,146 is a continuation of application No. 11/768,133, filed on Jun. 25, 2007, now abandoned.
(60) Provisional application No. 60/816,213, filed on Jun. 23, 2006.

(51) Int. Cl. H01F 1/03

(52) U.S. Cl. CPC H01F 1/03
USPC 420/57

(57) ABSTRACT

The alloys of the present invention provide austenitic, paramagnetic materials with high strength, ductility, and yield strength and good corrosion resistance in media with high chloride concentrations. Alloys of the present invention were developed because of the need by oilfield industries for superior materials. The alloys of the present invention may be used in drilling string components, and the tests performed demonstrate that such alloys exhibit properties balanced for very high yield strength, magnetic permeability, and corrosion resistance superior in every respect to presently available paramagnetic, high strength, corrosion resistant austenitic stainless steels.

### CROSS-REFERENCE TO RELATED APPLICATION

This application is a continuation of U.S. patent application Ser. No. 13/157,146, filed Jun. 9, 2011, now pending, which is a continuation of U.S. patent application Ser. No. 11/768,133, filed Jun. 25, 2007, now abandoned, which claims the benefit under 35 U.S.C. §119(e) of U.S. Provisional Patent Application No. 60/816,213, filed Jun. 23, 2006, which applications are incorporated herein by reference in their entirety.

### BACKGROUND OF THE INVENTION

1. Field of the Invention

The present invention relates generally to austenitic, paramagnetic and corrosion-resistant materials having high strength, yield strength, and ductility for use in media with high chloride concentrations, and, more particularly, to steels suitable for use in non-magnetic components in oilfield technology, especially in directional drilling of oil and gas wells.

2. Description of the Related Art

High-strength materials that are paramagnetic, corrosion-resistant and which, for economic reasons, consist essentially of alloys of chromium, manganese, and iron are used for manufacturing chemical apparatuses, in devices for producing electrical energy, and, in particular, for components, devices and equipment in oil field technology. Chromium-manganese stainless steels have been favored in the manufacture of such parts because they satisfy the requirements of non-magnetic behavior, high yield strength, and good resistance to chloride stress corrosion cracking, all at a reasonable cost. However, increasingly higher demands are being placed on the chemical corrosion properties as well as the mechanical characteristics of materials used in this manner.

In these types of stainless steels, it is indispensable for the behavior of the material to be completely homogeneous and highly paramagnetic. For example, in cap rings of generators with high yield strength and ductility, a possible low-level ferromagnetic behavior must be excluded with utmost certainty. For measurements during drilling, in particular exploration wells in crude oil or natural gas fields, drill stems made of materials with magnetic permeability values below about 1.02 or possibly even less than 1.01 (using a Severn gauge) are necessary in order to be able to follow the exact position of the bore hole and to ascertain and correct deviations from its projected course.

It is furthermore necessary for devices in oil field technology and drill stem components to have high mechanical strength, in particular a high yield strength at 0.2% offset, in order to achieve machinery and plant engineering advantages as well as a high degree of operational reliability. In many cases, high fatigue strength under reversed stresses is just as important because pulsating or alternating stresses may be present during rotation of a part and/or drill stems. Finally, the corrosion behavior of the material in aqueous media, in particular media having high chloride concentrations, is critically important.

As a result of the demands of recent developments in deep drilling technology, increasingly stricter criteria are being placed on materials in terms of the combination of paramagnetic behavior and high yield strength, as well as strength, resistance to chloride-induced stress corrosion, especially resistance to pitting corrosion (pitting), and crevice corrosion. Some materials made from Cr—Mn—Fe alloys are known which, with respect to their mechanical characteristics and corrosion behavior, completely fulfill these requirements. However, their magnetic permeability values prevent their use in parts used in connection with magnetic measurements and exclude their use for drill stems. On the other hand, available paramagnetic materials with good strength characteristics cannot resist attacks by corrosion and, for the most part, paramagnetic parts with high corrosion resistance often do not have the necessary high mechanical values.

Control of pitting corrosion resistance, is very important in measurement while drilling (MWD) components where, due to complex internal geometry, mud deposits can form and produce crevices for corrosion pits to grow. Pitting corrosion resistance of a material can be predicted by PREN values of the material, wherein the PREN value is defined as (wt-% Cr)+(3.3)(wt-% Mo)+(16)(Wt-% N). Pitting is a local attack that can produce penetration of a stainless steel with negligible weight loss to the total structure. Pitting is associated with a local discontinuity of the passive film. It can be a mechanical imperfection, such as surface damage or inclusion, or it can be a local chemical break down of the film. Chloride is the most common agent for initiation of pitting. Once a pit is formed, it in effect becomes a crevice. The stability of the passive film with respect to resistance to pitting initiation is controlled primary by chromium, molybdenum and nitrogen.

Use of nitrogen to improve mechanical and chemical corrosion properties of substantially Cr—Mn—Fe alloys is known, however, this requires expensive metallurgic processes operating at elevated pressure. For economic reasons, Cr—Mn—Fe alloys have been developed that can be produced without pressurized smelting or similar casting processes, i.e., at atmospheric pressure, in which a desired characteristic profile of the material is achieved using alloying technology (PCT Publication No. WO98/48070). For the purpose of improving corrosion resistance, these alloys have a molybdenum content of over 2%. This results in improved pitting and crevice corrosion behavior. However, molybdenum, like chromium, is a ferrite former and can lead to unfavorable magnetic characteristics in the material in segregation areas. While increased nickel contents stabilize the austenite, possibly in conjunction with increased copper concentrations, it has been believed that increased nickel content may have a detrimental effect on the mechanical characteristics and intensify crack initiation.

There are many alloys from the chromium-manganese austenitic stainless steel group that have long been known and are presently available. PCT Publication No. WO91/016469 makes an attempt to use a balanced concentration of alloy elements to create an austenitic, antimagnetic, rust-proof steel alloy that, during hot working, has a beneficial combination of characteristics without further tempering. European Patent No. EP-0207068 B1 suggests a process for improving mechanical characteristics of paramagnetic drill string parts in which a material is subjected to a hot and a cold forming, with the cold forming taking place at a temperature between 100° C. and 700° C. and a degree of deformation of at least 5%.

More recently, U.S. Pat. No. 6,454,879 described an austenitic, paramagnetic and corrosion-resistant material comprised of carbon, silicon, chromium, manganese, nitrogen, and optionally, nickel, molybdenum, copper, boron, and carbide-forming elements. This patent teaches that levels below about 0.96 wt-% of nickel and below about 0.3 wt-% copper are needed to achieve the desired degree of corrosion resistance. However, at these low levels of nickel and copper (these two elements being austenite formers), low levels of molybdenum and/or chromium (being ferrite forming elements) must be present for a stable metallurgical structure, and therefore this steel fails to meet the desired level of pitting corrosion resistance.

Recent developments in deep-well drilling methods have demanded more stringent requirements on the materials and parts. These parts are required to operate in increasingly severe chloride environments and at the same time the drilling is done in much deeper levels where the parts are required to have much higher yield strengths. None of the steels discussed above have all of the desired properties of yield strength and pitting corrosion resistance necessary for acceptable performance under these more exacting operating conditions.

Accordingly, although there have been advances in the field, there remains a need in the art for alloys with a higher critical pitting potential which can be forged to very high yield strengths while maintaining their paramagnetic properties, high toughness, and microstructures free from carbides, nitrides, and sigma and chi phase precipitation. The alloys of the present invention address these needs and provide further related advantages.

### BRIEF SUMMARY OF THE INVENTION

In brief, the present invention is directed to austenitic, paramagnetic and corrosion-resistant materials having high strength, yield strength, and ductility for use in media with high chloride concentrations. The invention provides alloys suitable for use in non-magnetic components in oilfield technology, especially in directional drilling of oil and gas wells.

In one embodiment, an austenitic, paramagnetic material with high strength, ductility, and yield strength and good corrosion resistance in media with high chloride concentrations is provided, comprising (in wt-%): up to about 0.035 carbon; about 0.25 to about 0.75 silicon; about 22.0 to about 25.0 manganese; about 0.75 to about 1.00 nitrogen; about 19.0 to about 23.0 chromium; about 2.70 to about 5.00 nickel; about 1.35 to about 2.00 molybdenum; about 0.35 to about 1.00 copper; about 0.002 to about 0.006 boron; up to about 0.01 sulfur; up to about 0.030 phosphorous; and substantially no ferrite content.

In a further embodiment, the material comprises about 2.70 to about 4.25 wt-% nickel. In yet a further embodiment, the material comprises about 2.75 to about 4.20 wt-% nickel. In yet a further embodiment, the material comprises about 3.50 to about 4.20 nickel.

In another further embodiment, the material comprises about 0.35 to about 0.85 wt-% copper. In yet a further embodiment, the material comprises about 0.35 to about 0.75 wt-% copper. In yet a further embodiment, the material comprises about 0.50 to about 0.75 copper.

In another further embodiment, the material comprises (in wt-%): up to about 0.030 carbon; about 0.25 to about 0.45 silicon; about 22.0 to about 23.0 manganese; about 0.75 to about 0.90 nitrogen; about 19.0 to about 20.0 chromium; about 2.70 to about 4.25 nickel; about 1.40 to about 1.80 molybdenum; about 0.35 to about 0.75 copper; about 0.003 to about 0.006 boron; up to about 0.006 sulfur; and up to about 0.025 phosphorous. In yet a further embodiment, the material comprises (in wt-%): up to about 0.028 carbon; about 0.30 to about 0.45 silicon; about 22.0 to about 23.0 manganese; about 0.78 to about 0.90 nitrogen; about 19.0 to about 20.0 chromium; about 3.50 to about 4.20 nickel; about 1.40 to about 1.75 molybdenum; about 0.50 to about 0.75 copper; about 0.003 to about 0.006 boron; up to about 0.003 sulfur; and up to about 0.20 phosphorous.

In another further embodiment, the material has a PREN value of greater than about 37. In yet a further embodiment, the material has a PREN value of greater than about 37 and less than about 39.

In another further embodiment, the material has a yield strength at 0.2% offset of greater than about 140 ksi. In yet a further embodiment, the material has a yield strength at 0.2% offset of greater than about 140 ksi and less than about 190 ksi.

In another further embodiment, the material has a PREN value of greater than about 37 and a yield strength at 0.2% offset of greater than about 140 ksi. In yet a further embodiment, the material has a PREN value of greater than about 37 and less than about 39 and a yield strength at 0.2% offset of greater than about 140 ksi and less than about 190 ksi.

These and other aspects of the invention will be evident upon reference to the following detailed description.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known aspects of steel alloys have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment of alloys of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The present invention provides an austenitic, paramagnetic material with high strength, ductility, and yield strength and good corrosion resistance in media with high chloride concentrations, comprising, silicon, manganese, nitrogen, chromium, nickel, molybdenum, copper, boron, and positive amounts of carbon, sulfur, and phosphorous; the balance including iron. The material has substantially no ferrite content and is preferably substantially completely austenitic. The material has a higher critical pitting potential than previous alloys and can be forged to very high yield strengths in sections as large as 12.75 inches in diameter. The material in this form maintains its paramagnetic properties, very high toughness, and a microstructure free from carbide, nitrides, and sigma and chi phase precipitation. A process for producing the material and beneficial representative methods of use are provided.

The alloys of the present invention are produced using a cost effective basic electric arc furnace melting procedure. Secondary refining of the material utilizing the Argon-Oxygen Decarburization (AOD) process provides precise chemistry control and uniform teeming temperatures. The AOD process allows for low sulfur and oxygen levels resulting in exceptionally clean steel.

Oil-well drilling components made from alloys of the present invention are manufactured by the open die forging technique, using a warm forging process to achieve the desired mechanical properties. To obtain the best corrosion properties, alloys of the present invention are solution annealed at 1900° F. before final forging. Materials manufactured under these conditions have high yield strengths (>144 ksi) and PREN values (>37.00) and very good Critical Pitting Potential (400 mV in 80,000 ppm Cl solution) as well as meeting the desired minimum requirements for magnetic permeability (not greater than 1.004 using a Dr. Foerster magnetoscope (model 1.067)) and intergranular corrosion resistance per ASTM 262 A (step structure only), minimum hardness (341 HBN), and notch impact strength (122 J).

Carbon strongly contributes to austenitic formation and to stabilization of the austenite against transformation of martensite. However, high carbon content also leads to precipitation of chromium carbides which leads to impaired corrosion properties, embrittlement in the alloy, and a destabilization of the austenite and possibly local martensite transformation. This in itself can make the material partially ferromagnetic. Higher carbon contents also lead to pitting and corrosion in chloride-containing media as well as to intergranular corrosion of parts manufactured therefrom. Carbon also has limited solubility in austenite and higher concentrations can lead to precipitation of chromium carbides. Because of the negative effects of higher carbon concentrations, alloys of the present invention do not exceed about 0.035% by weight and in some embodiments carbon does not exceed about 0.030 wt-%. Further embodiments of alloys of the present invention do not exceed about 0.028 wt-% carbon.

Silicon is present in the alloys of the present invention as a deoxidation element with a concentration of about 0.25 to about 0.75 wt-% in some embodiments. Substantially higher contents of silicon can lead to nitride formation and to a decrease in resistance of the material to stress corrosion. Because silicon also has a strong ferrite-forming effect, higher contents can negatively influence magnetic permeability. Thus, some embodiments of the alloys of the present invention incorporate silicon in the range of 0.25 to 0.45 wt-% while other embodiments incorporate about 0.30 to about 0.45 wt-% silicon.

Manganese is added to the alloys of the present invention to increase the solubility of nitrogen in the melted and solid phase (austenite) and to stabilize the austenite. The upper limit of manganese in alloys of the present invention is restricted to a maximum of about 25.0 wt-%. Manganese will form some austenite but is added primarily to stabilize the austenite and for holding large amounts of nitrogen in solution, but in contents above about 25 wt-% in alloys of the present invention, manganese acts as a ferritic former, thus the levels of manganese in some embodiments of the alloys of the present invention are controlled from about 22.0 to about 25.0 wt-% with other embodiments in the range of about 22.0 to about 23.0 wt-%.

Nitrogen is beneficial to austenitic stainless steels because it enhances pitting resistance, retards the formation of the chromium-molybdenum sigma phase, and increases yield strengths of the steels. Nitrogen in solid solution is the most beneficial alloying element for promoting high strength in austenitic stainless steels without negatively affecting their ductility and toughness properties so long as the solubility limit of nitrogen in the austenite is not exceeded. If the solubility limit is exceeded, Cr₂N precipitates and/or gas porosity formation takes place, which deteriorates corrosion resistance, ductility and toughness. Thus embodiments of the alloys of the present invention limit nitrogen content to about 0.75 to about 1.00 wt-% while other embodiments are in the range of about 0.75 to about 0.90 wt-% nitrogen. Further embodiments incorporate from about 0.78 to about 0.90 wt-% nitrogen.

Chromium is important in the alloys of the present invention for several reasons. For good corrosion resistance high chromium content is needed. Chromium is the element essential in forming the passive film. While other elements can influence the effectiveness of chromium in forming or maintaining the film, no other element can, by itself, create this property of stainless steel. For high corrosion resistance values, the chromium content of the alloys of the present invention should be at least about 19.0% by weight. Chromium increases the nitrogen solubility both in the melt and in the solid phase and thereby enables an increased nitrogen content in the alloy. High chromium content also contributes to stabilizing the austenite phase against martensite transformation. On the other hand, because chromium is a ferrite stabilizing element, the presence of very high percentages of chromium, will lead to the presence of ferromagnetic ferrite. To maintain the paramagnetic properties of the alloys of the present invention, the chromium content in some embodiments is about 19.0 to about 23.0% by weight, while in other embodiments the chromium content is in the range of about 19.0 to about 21.0 wt-%. Further embodiments incorporate chromium in the range of about 19.0 to about 20.0 wt-%.

Nickel, after carbon and nitrogen, is the most effective austenite stabilizing element. Nickel increases austenite stability against deformation into martensite and increases yield strength, toughness, and the pitting corrosion resistance of the material. Nickel makes ferritic grades of stainless steels susceptible to stress corrosion cracking in chloride solutions; however in austenitic stainless steels, nickel is effective in promoting repassivation. U.S. Pat. No. 6,454,879 teaches that nickel should be restricted to levels below the level in the alloys of present invention, preferably below 0.96 wt % for sufficiently good corrosion characteristics. Contrary to this teaching, it has been surprisingly found that about 1-2 wt-% nickel is necessary to optimize the ability of the alloys of the present invention to passivate. However, in order to decrease the active corrosion rate, a minimum of about 2.7 wt-% (preferably a minimum of about 3 wt-%) nickel is needed.

In alloys of the present invention, nickel improves the critical pitting corrosion potential of the alloy in neutral solutions at room temperature to greater than 450 mV in 80,000 ppm chloride solution. This value is higher than all commercially available Cr—Mn—N austenitic stainless steels. In alloys of the present invention, a minimum of about 2.70 wt-% nickel is necessary to achieve the austenitic structure and allow a high enough Mo content in the alloys to maximize the corrosion resistance properties of the alloys of the present invention. High nickel content in the alloys of the present invention is needed to protect the austenitic structure from formation of delta ferrite or sigma phase. Thus, some embodiments of the alloys of the present invention incorporate nickel from about 2.70 to about 5.00 wt-% while other embodiments incorporate from about 2.70 to about 4.25 wt-% nickel. Further embodiments incorporate about 2.75 to about 4.20 wt-% nickel while even further embodiments incorporate about 3.50 to about 4.20 wt-% nickel.

Molybdenum in combination with chromium is very effective in terms of stabilizing the passive film in the presence of chlorides. Molybdenum is especially effective in increasing resistance to the initiation of pitting and crevice corrosion. However, the amount of molybdenum that can be added to austenitic stainless steels is limited by the onset of sigma and chi phase precipitation, which embrittle the alloys and reduce pitting resistance. Nitrogen additions to molybdenum-free austenitic stainless steels improve pitting resistance; however, the effect of nitrogen is significantly enhanced in the presence of molybdenum. The combined beneficial effects of nitrogen and molybdenum are used in alloys of the present invention to increase resistance to pitting corrosion and to achieve a higher Critical Pitting Potential compared to commercially available Cr—Mn—N austenitic stainless steels. However, molybdenum is a strong ferrite former and its content must be controlled. For purposes of exploiting the beneficial effects of molybdenum without formation of any ferrite material, the molybdenum content of some embodiments of the alloys of the present invention is restricted to about 1.35 to about 2.00 wt-% while other embodiments incorporate about 1.40 to about 1.80 wt-% molybdenum. Even further embodiments have molybdenum concentration of about 1.40 to about 1.75 wt-%.

Copper affects the metallurgical stability in the alloys of the present invention. Copper is an austenitic stabilizer and is added to aid the paramagnetic properties of the alloys of the present invention. Copper up to a maximum of about 1.00 wt-% is beneficial in terms of its passivating ability, pitting corrosion resistance, and active corrosion rate. U.S. Pat. No. 6,454,879 teaches that copper in Cr—Mn—N austenitic steels should have a maximum of about 0.3 w-t % and preferably less than about 0.25 wt-% in order to achieve a desired degree of corrosion resistance. In contrast to previous teachings, it has been surprisingly found, that a copper content of at least about 0.35 wt-% achieves the best corrosion properties. Thus, copper is present in some embodiments of the alloys of the present invention in amounts of about 0.35 up to about 1.00 wt-%, and in other embodiments copper is present in about 0.35 to about 0.85 wt-%. Further embodiments have a copper concentration of about 0.35 to about 0.75 wt-% with an even further embodiment having a copper concentration of about 0.50 to about 0.75 wt-%.

Boron is added to the alloys of the present invention in order to increase the intergranular corrosion resistance and pitting resistance of the alloys of the present invention. At too high a boron content, the corrosion resistance may be deteriorated. Therefore, the boron content in some embodiments of the alloys of the present invention is about 0.002 to about 0.006% by weight. Boron levels in other embodiments are about 0.003 to about 0.006 wt-%. At these levels, the boron will be in solution and provide beneficial effects on the pitting resistance. Boron also retards (Cr₂)₃C₆ precipitation and therefore has a beneficial effect on the intergranular corrosion resistance of the alloys of the invention.

Sulfur, especially in high manganese stainless steels, affects the corrosion resistance negatively by forming easily soluble sulfide inclusions. The morphology and composition of these sulfides can have a substantial effect on corrosion resistance, especially pitting resistance. Therefore, the sulfur content of the alloys of the present invention is limited to a maximum of about 0.01 wt-% in some embodiments. Other embodiments contain a maximum of about 0.006 wt-% sulfur. Sulfur contents of even further embodiments are about 0.003 wt-%.

Enrichment of Phosphorus together with chromium at the grain boundaries can form Cr—P compounds. Formation of Cr-rich phosphides can deplete the nearby region of Cr and cause intergranular corrosion. Therefore it is important that alloys of the present invention contain a minimum amount of phosphorous. Some embodiments of the alloys of the present invention contain up to about 0.030 wt-% phosphorous while other embodiments contain up to about 0.025 wt-% phosphorous. Still further embodiments contain up to about 0.020 wt-% phosphorous.

### EXAMPLES

A series of heats per alloys of the present invention were melted, and the bars were forged and tested for yield strength, tensile strength, elongation, reduction of area, and impact toughness. The composition of these heats are reported in Table 1 while the mechanical properties are reported in Tables 2 and 3. Tables 1-3 also compare various properties of alloys of the present invention with those of commercially available steels. As shown, the alloys of the present invention met the desired combination of properties for higher yield strength, higher pitting corrosion resistance, maintaining nonmagnetic permeability, and resistance to intergranular corrosion. All the foregoing samples met the desired criteria for magnetic permeability, yield strength, improved pitting corrosion resistance, interangular corrosion resistance, minimum hardness, and notch impact strength as set forth above.

TABLE 1
Chemical Composition (wt-%) and PREN

| Sample | Material | C | Mn | Cr | Ni | Mo | N | Cu | Si | S | B | P | PREN |
|---|---|---|---|---|---|---|---|---|---|---|---|---|---|
| A (2G237) | J38 | 0.016 | 22.08 | 19.55 | 2.73 | 1.74 | 0.819 | 0.35 | 0.38 | 0.003 | 0.006 | 0.020 | 38.40 |
| B (2G542) | J38 | 0.027 | 22.20 | 19.38 | 3.66 | 1.47 | 0.798 | 0.60 | 0.33 | 0.001 | 0.003 | 0.010 | 37.00 |
| C (1P880) | J38 | 0.024 | 22.46 | 19.71 | 3.91 | 1.44 | 0.843 | 0.52 | 0.30 | 0.002 | 0.004 | 0.011 | 37.95 |
| D (2G695) | J38 | 0.024 | 22.18 | 19.65 | 4.18 | 1.53 | 0.800 | 0.55 | 0.35 | 0.002 | 0.004 | 0.013 | 37.50 |
| 1 | P580 | 0.040 | 23.70 | 21.60 | 1.93 | 0.36 | 0.860 | 0.12 | 0.19 | 0.003 | 0.001 | 0.018 | 36.55 |
| 2 | Datalloy2 | 0.032 | 14.50 | 14.99 | 2.33 | 2.56 | 0.382 | 0.17 | 0.20 | 0.006 | 0.003 | 0.015 | 29.55 |
| 3 | P550 | 0.050 | 20.44 | 18.89 | 1.44 | 0.48 | 0.711 | 0.03 | 0.17 | 0.003 | 0.001 | 0.016 | 31.84 |
| 4 | NMS140 | 0.025 | 19.67 | 18.18 | 1.78 | 0.97 | 0.63 | 0.11 | 0.38 | 0.002 | 0.003 | 0.025 | 31.51 |

Materials A-D are the alloys of the present invention
Materials 1-4 are commercially available materials
1 = steel of U.S. Pat. No. 6,454,879
2 = steel of PCT Publication No. WO 99/23267
3 and 4 = commercially available

TABLE 2
Mechanical Properties

| | | Bar | Yield | Yield | Tensile | Tensile | | Reduction | Impact | Impact |
|---|---|---|---|---|---|---|---|---|---|---|
| | | Diameter | Strength | Strength | Strength | Strength | Elongation | of Area | Toughness | Toughness |
| Sample | Material | (in.) | (ksi) | (MPa) | (ksi) | (MPa) | (%) | (%) | (ft-lbs) | (J) |
| A (2G237) | J38 | 11 | 167 | 1151 | 179 | 1234 | 22.0 | 69 | 120 | 183 |
| B (2G542) | J38 | 8¾ | 144 | 993 | 166 | 1145 | 27.0 | 69 | 139 | 188 |
| C (1P880) | J38 | 10 | 148 | 1020 | 169 | 1165 | 26.0 | 70 | 125 | 169 |
| D (2G695) | J38 | 10 | 144 | 993 | 163 | 1124 | 27.0 | 73 | 147 | 199 |
| 1 | P580 | 5½ | 165 | 1138 | 180 | 1241 | 23.0 | 66 | 62 | 84 |
| 4 | NMS140 | 11 | 143 | 986 | 163 | 1124 | 24.0 | 70 | 125 | 169 |

TABLE 3
Critical Pitting Potential and CP Temperature

| | | 50 | 100 | 200 | CPT |
|---|---|---|---|---|---|
| Sample | Material | (μA/cm²) | (μA/cm²) | (μA/cm²) | (° C.) |
| B (2G542) | J38 | 584 | 642 | 720 | 54.5 |
| 1 | P580 | 250 | 344 | 408 | — |
| 2 | Datalloy2 | −20 | −12 | 6 | — |
| 3 | P550 | −50 | −14 | 18 | <10 (1.9) |
| 4 | NMS140 | −29 | −14 | 2 | 14.6 |

### Critical Pitting Potential (CPP)

The test procedures used for this test followed the guidelines of ASTM G 5, Standard Reference Test Method for Making Potentiostatic and Potentiodynamic Anodic Polarization Measurements.

The test specimens were placed into a deaerated 80,000 ppm chloride solution buffered to 6.8-7.0 pH with a borax buffer at ambient temperature. A saturated calomel electrode (SCE) was used as the reference electrode and platinum mesh as the counter electrode. The test specimens were allowed to equilibrate with the test solution for 1 hour prior to initiation of the test. Starting with −600 mV vs. SCE, the potential was increased at a rate of 0.1 mV/s.

### Critical Pitting Temperature (CPT)

The critical pitting temperature (CPT) was determined in accordance to ASTM G 150, Standard Test Method for Electrochemical Critical Pitting Temperature Testing of Stainless Steels. Specimens were placed in a 1 molar solution of NaCl in a cell with a calomel reference electrode and a platinum counter electrode. The solution was aerated in air and a potential of +700 mV was applied between the sample and the reference electrode. The temperature was increased at 1° C./min. The CPT was determined to be the temperature at which a current density of 100 μA/cm² was observed.

All of the U.S. patents, U.S. patent application publications, U.S. patent applications, foreign patents, foreign patent applications and non-patent publications referred to in this specification and/or listed in the Application Data Sheet are incorporated herein by reference, in their entirety.

While particular steps, elements, embodiments and applications of alloys of the present invention have been shown and described herein for purposes of illustration, it will be understood, of course, that the invention is not limited thereto since modifications may be made by persons skilled in the art, particularly in light of the foregoing teachings, without deviating from the spirit and scope of the invention. Accordingly, the invention is not limited except as by the appended claims.

What is claimed is:

1. An austenitic, paramagnetic material with high strength, ductility, and yield strength and good corrosion resistance in media with high chloride concentrations, comprising (in wt-%):
up to about 0.035 carbon;
about 0.25 to about 0.75 silicon;
about 22.0 to about 25.0 manganese;
about 0.75 to about 1.00 nitrogen;
about 19.0 to about 23.0 chromium;
about 2.70 to about 5.00 nickel;
about 1.35 to about 2.00 molybdenum;
about 0.35 to about 1.00 copper;
about 0.002 to about 0.006 boron;
up to about 0.01 sulfur;
up to about 0.030 phosphorous; and
substantially no ferrite content.

2. The material according to claim 1, wherein the material comprises about 2.70 to about 4.25 wt-% nickel.

3. The material according to claim 2, wherein the material comprises about 2.75 to about 4.20 wt-% nickel.

4. The material according to claim 3, wherein the material comprises about 3.50 to about 4.20 nickel.

5. The material according to claim 1, wherein the material comprises about 0.35 to about 0.85 wt-% copper.

6. The material according to claim 5, wherein the material comprises about 0.35 to about 0.75 wt-% copper.

7. The material according claim 6, wherein the material comprises about 0.50 to about 0.75 copper.

8. The material according to claim 1, wherein the material comprises (in wt-%):
up to about 0.030 carbon;
about 0.25 to about 0.45 silicon;
about 22.0 to about 23.0 manganese;
about 0.75 to about 0.90 nitrogen;
about 19.0 to about 20.0 chromium;
about 2.70 to about 4.25 nickel;
about 1.40 to about 1.80 molybdenum;
about 0.35 to about 0.75 copper;
about 0.003 to about 0.006 boron;
up to about 0.006 sulfur; and
up to about 0.025 phosphorous.

9. The material according to claim 8, wherein the material comprises (in wt-%):
up to about 0.028 carbon;
about 0.30 to about 0.45 silicon;
about 22.0 to about 23.0 manganese;
about 0.78 to about 0.90 nitrogen;
about 19.0 to about 20.0 chromium;
about 3.50 to about 4.20 nickel;
about 1.40 to about 1.75 molybdenum;
about 0.50 to about 0.75 copper;
about 0.003 to about 0.006 boron;
up to about 0.003 sulfur; and
up to about 0.020 phosphorous.

10. The material according to claim 1, wherein the material has a PREN value of greater than about 37.

11. The material according to claim 10, wherein the material has a PREN value of greater than about 37 and less than about 39.

12. The material according to claim 1, wherein the material has a yield strength at 0.2% offset of greater than about 140 ksi.

13. The material according to claim 12, wherein the material has a yield strength of greater than about 140 and less than about 190 ksi.

14. The material according to claim 1, wherein the material has a PREN value of greater than about 37 and a yield strength at 0.2% offset of greater than about 140 ksi.

15. The material according to claim 14, wherein the material has a PREN value of greater than about 37 and less than about 39 and a yield strength at 0.2% offset of greater than about 140 and less than about 190 ksi.
